(19) United States
(12) Patent Application Publication
(10) Pub. No.: US 2008/0079243 A1
(43) Pub. Date: Apr. 3, 2008

(54) Head protecting airbag

(75) Inventors: Masao Kino, Aichi-ken (JP); Tadashi Yamamoto, Aichi-ken (JP); Yasushi Masuda, Aichi-ken (JP); Hitoshi Kawabe, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/902,671

(22) Filed: Sep. 25, 2007

(30) Foreign Application Priority Data
Sep. 29, 2006 (JP) 2006-267850

(51) Int. Cl. B60R 21/213

(52) U.S. Cl. 280/728.2

(57) ABSTRACT

A head protecting airbag according to the invention has a plurality of mounting portions which is mounted at an upper edge part of the airbag and which is used to mount the airbag to an upper edge part of a vehicle window. The airbag is formed by a hollow weave consisting of warp and weft threads. The mounting portion includes a mounting hole. The mounting portion includes an adjacent marginal portion which extends from a marginal border portion and is formed of a hollow weave hollow-woven as a single-ply so as to connect an interior-side wall portion to an exterior-side wall portion, so that the adjacent marginal portion constitutes a marginal part of the mounting hole. The mounting portion also includes an outer edge portion which is disposed on an outer circumferential side of the adjacent marginal portion and has two cloth pieces formed of the adjacent marginal portion by being separated into an interior-side part and an exterior-side part which are then woven.

### BACKGROUND OF THE INVENTION

1. Field of the Invention

The present invention relates to a head-protecting airbag enabled to protect an occupant's head by feeding a flow of inflation gas into the airbag from an upper edge part of a vehicle window (i.e., a side window) so as to expand and inflate the airbag to cover the interior side of the window.

2. Related Art

A conventional head protecting airbag is folded to and accommodated in an interior-side upper edge part of a vehicle window. When inflation gas flows into the airbag, the airbag expands and inflates to cover the interior side of the window. A plurality of mounting portions, through each of which a mounting hole for attaching the airbag to the upper edge part of the window is passed, are provided in an upper edge part of the airbag brought into a state in which the expansion and inflation thereof are completed (see, e.g., JP-A-2004-299483).

This airbag is formed by a hollow weave consisting of warp and weft threads. This airbag has a gas inflow portion configured to be inflated by inflow of inflation gas thereinto so as to separate a vehicle interior side wall portion and a vehicle exterior side wall portion from each other. This airbag also has a non-inflow portion, into which no inflation gas is flowed. The gas inflow portion has a protection inflation portion configured to inflate so as to cover a window. The non-inflation portion has a marginal border portion configured to surround a marginal part of the gas inflow portion, and a mounting portion.

In the conventional head protecting airbag, the mounting portion extends upwardly from the marginal border portion and is constituted by a hollow weave that is hollow-woven as a single-ply.

In a case where the mounting portion is constituted by a hollow weave, which is hollow-woven as a single-ply, like the conventional head protecting airbag, the strength of a part in the vicinity of the mounting portion is high. However, in a case where a large downward tensile force acts upon the mounting portion when the airbag expands and inflates after attached to a vehicle, there is a fear that weft or warp threads constituting a marginal part of the mounting hole receive the tensile force and become frayed, that this fray runs to an edge part of the mounting portion, and that the mounting portion is damaged and disengages from a mounting means which attaches the mounting portion to a vehicle body. In consideration of this respect, the size of the mounting portion (i.e., the distance from the mounting hole to the edge in the mounting portion) is set to be large.

To solve the problems, it can be considered that the mounting portion is constituted by a hollow weave which is hollow-woven as a two-ply. Warp or weft threads constituting the mounting portion constituted by a hollow weave, which is hollow-woven as a two-ply, are difficult to fray, as compared with those of the mounting portion constituted by a hollow weave woven as a single-ply. Thus, the strength of a part in the vicinity of the mounting portion is low. To assure the strength, a conventional head protecting airbag has a mounting portion formed by folding back two cloth pieces, which are woven by separating the marginal part into a vehicular inner cloth part and a vehicular outer cloth part, so as to have a four-ply structure (see, for example, JP-A-2006-168690).

However, because the mounting portion is constituted by a four-ply piece of cloth in the head protecting airbag described in JP-A-2006-168690, an operation of folding back the two cloth pieces is necessary. Additionally, to integrate this piece of cloth, the marginal part of the mounting hole is sewn, so that the number of steps of a manufacturing process increases. Consequently, there is room for improvement in reduction in the number of steps of the manufacturing process for and in the cost of the conventional head protecting airbag.

### SUMMARY OF THE INVENTION

The invention solves the aforementioned problems. An object of the invention is to provide a head protecting airbag which is easy to manufacture and is enabled so that a mounting portion is stably attached to a vehicle body without being damaged even in a case where a large tensile force acts drastically and directly on a marginal part of a mounting hole of the mounting portion when the airbag expands and inflates.

According to the invention, there is provided a head protecting airbag configured so that the airbag is folded and accommodated in an interior-side upper edge part of a window, that the airbag expands and inflates, when inflation gas flows thereinto, to cover an interior side of the window, that the airbag has a plurality of mounting portions for mounting the airbag in a part of a vehicle body at an upper edge side of the window, which are provided in an upper edge part thereof in a state in which expansion and inflation thereof are completed, that a mounting hole, through which mounting means to be connected to the part of the vehicle body is passed, is provided in each of the mounting portions, and that the airbag is formed of a hollow weave including warp and weft threads. The head protecting airbag features that the airbag comprises a gas inflow portion configured to be inflated by flowing inflation gas thereinto to separate an interior-side wall portion from an exterior-side wall portion, and a non-inflow portion in which no inflation gas is flowed. The head protecting airbag also features that the non-inflow portion has the mounting portions and marginal border portions surrounding the gas inflow portion, and that each of the mounting portions includes an adjacent marginal portion which is provided to extend outwardly from the marginal border portion and which is formed of a hollow weave as a single-ply so as to connect the interior-side wall portion and the exterior-side wall portion to each other and as to constitute a marginal border of an associated one of the mounting holes, and an outer edge portion including two cloth pieces which are arranged on an outer circumferential side of the adjacent marginal portion and are formed of the adjacent marginal portion by being separated from each other into an interior side part and an exterior side part.

In the head protecting airbag according to the invention, the adjacent marginal portion constituting the circumferential edge of the mounting hole of the mounting portion is constituted by the hollow weave hollow-woven as a single-ply to as to connect the interior-side wall portion to the exterior-side wall portion. Additionally, the outer edge portion constituted by the two cloth pieces, which are formed of the adjacent marginal portion by being separated into the interior-side part and the exterior-side part that are then woven, is provided at the outer circumferential side of this adjacent marginal portion. Thus, in the head protecting airbag according to the invention, when the airbag is expanded and inflated, a large downward tensile force drastically acts on the mounting portions. Even in a case where when receiving the tensile force, the warp and weft threads of the adjacent marginal portion may fray, in a border part between the adjacent marginal portion and the outer edge portion, in which the weave changes, the warp and weft threads become difficult to come off, due to resistance caused by the interweaving between the warp and weft threads of each of the two separate cloth pieces. Consequently, occurrence of a fraying phenomenon can be prevented. Also, such a fraying phenomenon can be suppressed from running to the outer edge portion provided at the outer circumferential side of the adjacent marginal portion. Consequently, according to the head protecting airbag of the invention, even when a large tensile force acts directly and drastically on the circumferential edge of the mounting hole of the mounting portion, the circumferential edge of the mounting hole can be prevented from fraying. Also, the mounting portion can be prevented from being damaged. Even when frays are caused over the entire adjacent marginal portion in the head protecting airbag according to the invention, frays can be prevented from running to the outer edge portion. Thus, it is unnecessary to increase the size of the mounting portion beyond necessity. As compared with the case of employing the mounting portion constituted by a hollow weave the entire of which is hollow weaved as a single-ply, the mounting portion can be compacted. Additionally, according to the head protecting airbag of the invention, the adjacent marginal portion and the outer edge portion of the mounting portion can be integrally manufactured when the airbag is hollow-woven. Consequently, the number of manufacturing-man-hours and the manufacturing cost can also be suppressed from increasing.

Accordingly, the head protecting airbag according to the invention is easy to manufacture and is enabled so that each mounting portion is stably attached to a vehicle body without being damaged even in a case where a large tensile force acts drastically and directly on a marginal part of a mounting hole of the mounting portion when the airbag expands and inflates.

The head protecting airbag can be configured so that the two cloth pieces constituting the outer edge portion are formed by scattering stitched portions thereover, which are formed by interweaving, when at least one of the two pieces is woven, the warp thread or the weft thread used to weave at least one of the two cloth pieces into the other cloth piece. Thus, the two cloth pieces of the outer edge portions are partially connected by the stitched portion. This head protecting airbag is preferable in that the two cloth pieces can be prevented from slipping off each other.

Preferably, in the head protecting airbag of the above configuration, practically, the hollow weave constituting the adjacent marginal portion is constituted by a 4×4 weave or a 3×3 weave. Additionally, preferably, in each of the adjacent marginal portions, a distance from an associated one of the mounting holes to an associated one of the outer edge portions, which is disposed at a side opposite to a direction in which a tensile force acting on the mounting portion acts, is 10 mm or more.

Preferably, in the head protecting airbag of the aforementioned configuration, particularly, each of the outer edge portions is such that a width of a part disposed at a side opposite to a direction, in which a tensile force acting on the mounting portion acts, is 5 mm or more.

### BRIEF DESCRIPTION OF THE DRAWINGS

FIG. 1 is a schematic front view illustrating a state in which an airbag apparatus using a head protecting airbag according to an embodiment of the invention is mounted in a vehicle.

FIG. 2 is a cross-sectional view of a part taken on line II-II shown in FIG. 1.

FIG. 3 is a front view illustrating an airbag according to the embodiment.

FIG. 4 is a partly enlarged from view of apart in which a mounting portion of the airbag according to the embodiment is provided.

FIG. 5 is a cross-sectional view illustrating a part taken on line V-V shown in FIG. 4.

FIG. 6 is a schematic view illustrating an example of the weave of an adjacent marginal portion in the airbag according to the invention.

FIG. 7 is an enlarged cross-sectional view illustrating a part taken on line VII-VII shown in FIG. 4.

FIG. 8 is a schematic view illustrating another example of the weave of an adjacent marginal portion in the airbag according to the embodiment.

FIG. 9 is a cross-sectional view illustrating a state in which a modification of the airbag according to the embodiment.

### DETAILED DESCRIPTION OF THE PREFERRED EMBODIMENTS

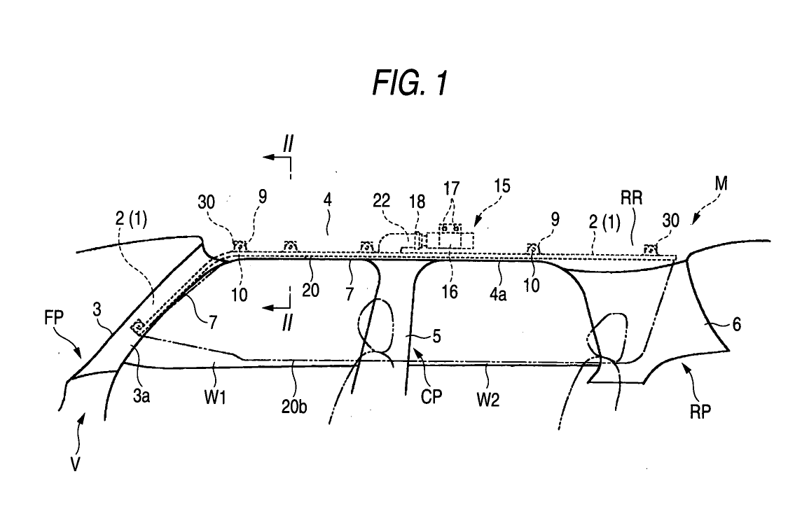

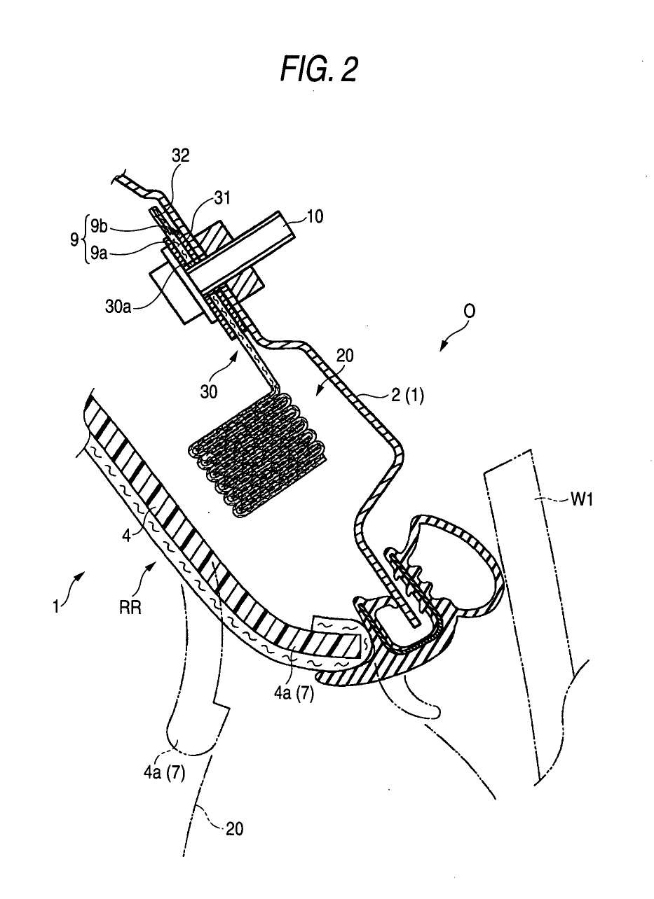

Hereinafter, an embodiment of the invention is described with reference to the accompanying drawings. As shown in FIGS. 1 and 2, a head protecting airbag (hereunder abbreviated “airbag”) 20 is used in a head protecting airbag apparatus M mounted in a vehicle V. As illustrated in FIGS. 1 and 2, the head protecting airbag apparatus M has the airbag 20, an airbag cover 7, an inflator 15, and mounting brackets 9 and 16. The airbag 20 is folded and accommodated in the upper edge side of each of side windows W1 and W2 at the interior side of the vehicle V in a range from the bottom edge of a front pillar portion FP through lower edge of a roof side rail portion PR to a top side of a roof side rail portion RR.

As illustrated in FIG. 1, a connecting port portion 22, through which inflation gas (to be described later) of the airbag 20 flows, is externally attached to the inflator 15 of the cylinder type shaped like a substantially circular cylinder, which is connected to the airbag 20 by utilizing a clamp 18. The inflator 15 is mounted on and fixed to an inner panel 2 of the roof side rail portion RR in the vicinity of the top of a center pillar portion CP by utilizing the mounting bracket 16, and is covered with the bottom edge 4 of the roof head lining 4. Incidentally, the inner panel 2 is a member at the side of a body (or vehicle body) 1 of a vehicle V. The mounting bracket 16 is made of a metal-plate, and holds the inflator 15, and is fixed to the inner panel 2 by utilizing bolts 17.

The airbag cover 7 is constituted by parts respectively corresponding to the bottom edge 3a of a front pillar garnish 3 disposed at a front pillar portion FP, and the bottom edge 4a of a roof head lining 4 disposed at the roof side rail portion RR. Incidentally, each of the front pillar garnish 3 and the roof head lining 4 is made of a synthetic resin and is mounted on and fixed to an interior-side part of the inner panel 2 at the side of a body 1. The roof head lining 4 is provided in a range from the vicinity of the top of the front pillar portion FP through the top of the center pillar portion CP and to the vicinity of the top of a rear pillar portion RP.

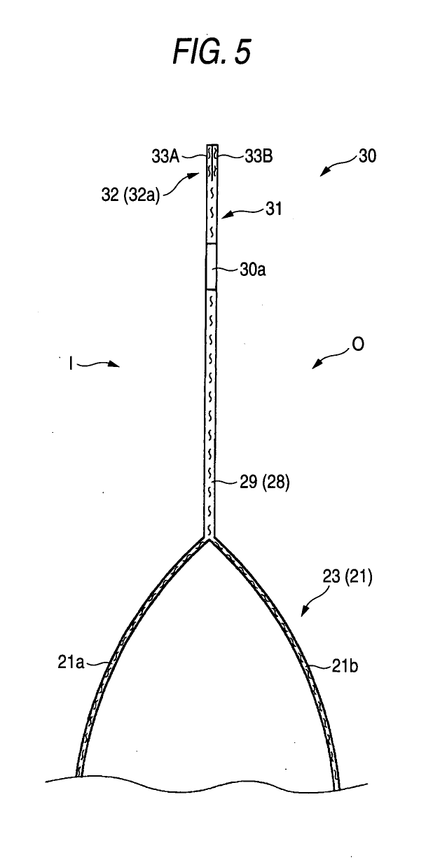

As illustrated in FIGS. 1, and 3 to 7, the airbag 20 is manufactured using a hollow weave constituted by warp threads VT and weft threads HT, which are polyamide threads. The airbag 20 is expanded from a folded state by flowing inflation gas G thereinto from the inflator 15. Then, the airbag 20 expands and inflates to cover interior-side parts I of side windows W1 and W2, the center pillar garnish 5 of the center pillar portion CP, and the rear pillar garnish 6 of the rear pillar portion RP. The airbag 20 has a gas inflow portion 21, which is inflated by inflow of the inflation gas G thereinto so as to separate the interior-side wall portion 21a and the exterior-side wall portion 21b from each other, and a non-inflow portion 28 into which no inflation gas G flows.

In the case of the embodiment, the gas inflow portion 21 includes the connecting port portion 22, a gas supply path portion 23, and a protecting inflation portion 24. The gas supply path portion 23 is provided to linearly extend along the anteroposterior direction of the vehicle V at the side of a top edge 20a of the airbag 20. The connecting port portion 22 for causing the inflation gas G to flow into the gas inflow portion 21 from the inflator 15 is formed at a substantially middle part in the anteroposterior direction of the gas supply path portion 23. The gas supply path portion 23 is a part for causing the inflation gas G to flow from the connecting port portion 22 into parts of both anteroposterior sides of the vehicle V.

The protecting inflation portion 24 is an are a for protecting a head of an occupant seated in a seat in the vehicle V. The protecting inflation portion 24 has a front protecting inflation portion 25 and a rear protecting inflation portion 26, into which the protecting inflation portion 24 is compartmented in the anteroposterior direction by a plate-like portion 38. The front protecting inflation portion 25 is arranged at a front-side lower part of the gas supply path portion 23. When the airbag 20 expands and inflates, the front protecting inflation portion 25 is placed lateral to a front seat of the vehicle V and inflates so as to cover the side window W1 provided lateral to the front seat. The rear protecting inflation portion 26 is provided at a rear-side lower part of the gas supply path portion 23. When the airbag 20 expands and inflates, the rear protecting inflation portion 26 is placed lateral to a rear seat of the vehicle V and covers the side window W2 provided lateral to the rear seat. Upon completion of the inflation, the front protecting inflation portion 25 and the rear protecting inflation portion 26 are partitioned by partitioning-portions 36 and 37 which regulate a thickness, and inflate a plurality of cells 25a, 25b, 25c, 25d, 26a and 26b provided parallel to one another in the anteroposterior direction of the vehicle V.

The non-inflow portion 28 includes the marginal border portion 29, the mounting portion 30, the partitioning portions 36 and 37, the plate-like portion 38, a connecting cloth 39. The marginal border portion 29 is formed so as to surround the gas inflow portion. In the case of the embodiment, the non-inflow portion 28, which is other than an outer edge portion 32 (to be described later) of the mounting portion 30, is constituted by a hollow weave, which is hollow-woven as a single-ply to connect the interior-side wall portion 21a and the exterior-side wall portion 21b of the gas inflow portion 21.

The plate-like portion 38 is provided like a rectangular plate at a lower part of the gas supply path portion 23 between the protecting inflation portion 25 and the rear protecting inflation portion 26. This plate-like portion 38 is provided in order to assure the entire shape of the airbag 20 and to shorten a time to completion of the inflation by reducing the capacity of the gas inflow portion 21.

The partitioning portions 36 and 37 are arranged in the front protecting inflation portion 25 and the rear protecting inflation portion 26. The partitioning portion 36 is formed so as to break into each of the front protecting inflation portion 25 and the rear protecting inflation portion 26 from the bottom edge of the marginal border portion 29. The partitioning portion 37 is formed so as to extend frontwardly and downwardly from the upper front end of the plate-like portion 38. The partitioning portions 36 and 37 are provided in order to regulate the thickness of each of the front protecting inflation portion 25 and the rear protecting inflation portion 26 by partitioning, upon completion of the inflation of the front protecting inflation portion 25 and the rear protecting inflation portion 26, the front protecting inflation portion 25 and the rear protecting inflation portion 26 into cells 25a, 25b, 25c, 25d, 26a, and 26b serving as small chambers provided in parallel to one another in the anteroposterior direction so that the front protecting inflation portion 25 and the rear protecting inflation portion 26 can inflate substantially like a plate, instead of a sphere.

The connecting cloth 39 is sewed on a front end of the airbag 20. This connecting cloth 39 is provided so as to assure the entire shape of the airbag 20, and to shorten a time to completion of the inflation by reducing the capacity of the gas inflow portion 21, similarly to the plate-like portion 38. Additionally, the connecting cloth 39 is formed by dividing the gas inflow portion 21 in order to enhance the yield by reducing the size of the airbag 20 formed integrally using a hollow weave.

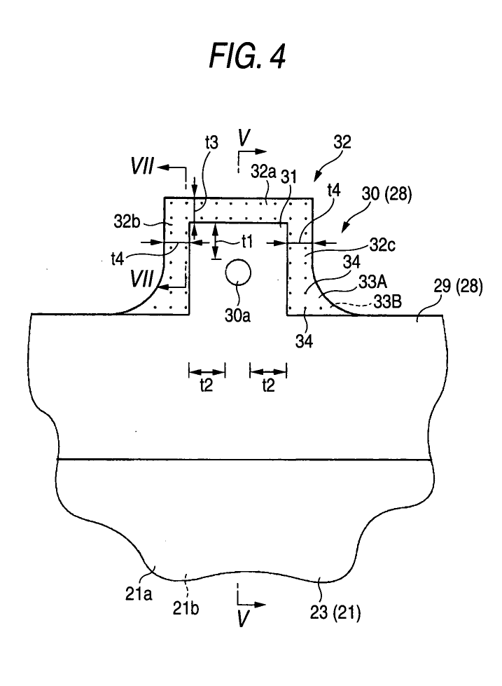

A plurality (six in the case of the present embodiment) of the mounting portions 30 are formed so as to protrude outwardly (upwardly in the case of the present embodiment) from the top edge 20a of the airbag 20. Each of the mounting portions 30 is provided with a mounting hole 30a which is passed through a mounting bolt 10 (to be described later) and is opened to be cross-sectionally substantially-circularly-shaped. Each of the mounting portions 30 includes an adjacent marginal portion 31 and an outer edge portion 32 arranged to the outer circumferential side of the adjacent marginal portion 31, as illustrated in FIGS. 4, 5, and 7.

The adjacent marginal portion 31 is provided so as to extend outwardly (upwardly in the case of the present embodiment) from the marginal border portion 29 and is constituted by a hollow weave, which is hollow-woven as a single-ply, so as to connect the interior-side wall portion 21a to the exterior-side wall portion 21b. In the case of the present embodiment, the adjacent marginal portion 31 is configured to extend substantially cross-sectionally rectangularly from the marginal border portion 29 so as to constitute the circumferential edge of the mounting hole 30a. Further, the adjacent marginal portion 31 is configured so that a distance from the mounting hole 30a to the outer edge portion 32 placed at a side opposite to a direction in which a tensile force acts on the mounting portion 30 when the airbag 20 expands and inflates, that is, each of a distance t1 from the top edge of the mounting hole 30a to the top end of the adjacent marginal portion, and a distance t2 from each of the front and rear edges of the mounting hole 30a to an associated one of the front and rear ends of the adjacent marginal portion is equal to or more than 10 mm (preferably, 10 mm to 20 mm) (see FIG. 4). In a case where each of the distances t1 and t2 is less than 10 mm, when the airbag 20 expands and inflates, so that a large tensile force acts on the mounting portion 30 downwardly, or obliquely frontwardly or rearwardly downwardly, the adjacent marginal portion 31 cannot withstand the tensile force. Thus, there is a fear that frays due to thread cast-off of the warp and weft threads may be caused at the circumferential edge of the mounting hole 30a, and that the adjacent marginal portion 31 may be damaged. Even in a case where each of the distances t1 and t2 is 20 mm or more, no more advantages can be obtained. Thus, waste of a material is caused. Preferably, each of the distances t1 and t2 is set to be less than 20 mm. In the case of the present embodiment, each of the distance t1 from the upper edge of the mounting hole 30a to the top end of the adjacent marginal portion and the distance t2 from each of the front and rear edges of the mounting hole 30a to an associated one of the front and rear ends of the adjacent marginal portion is set at 15 mm.

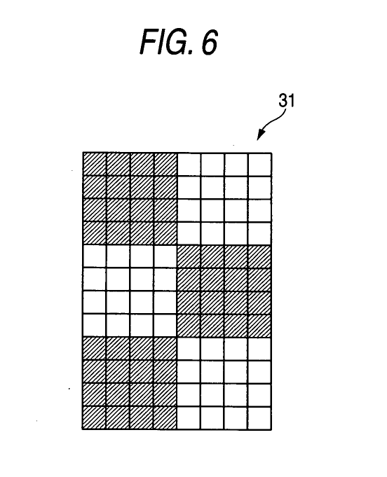

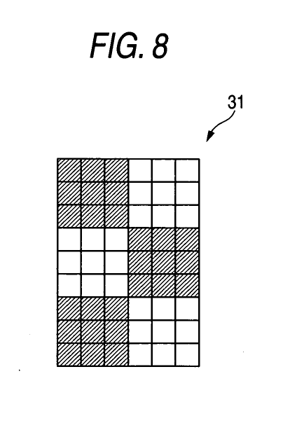

In the case of the present embodiment, as illustrated in FIG. 6, the adjacent marginal portion 31 is formed of a 4×4 basket weave. The weave constituting the adjacent marginal portion 31 is not limited thereto. As illustrated in FIG. 8, the adjacent marginal portion 31 can be formed of a 3×3 basket weave. The weave constituting the adjacent marginal portion 31 is not limited to the basket weave. As long as another weave can assure the strength similar to that of the basket weave, the adjacent marginal portion 31 can be constituted by another weave.

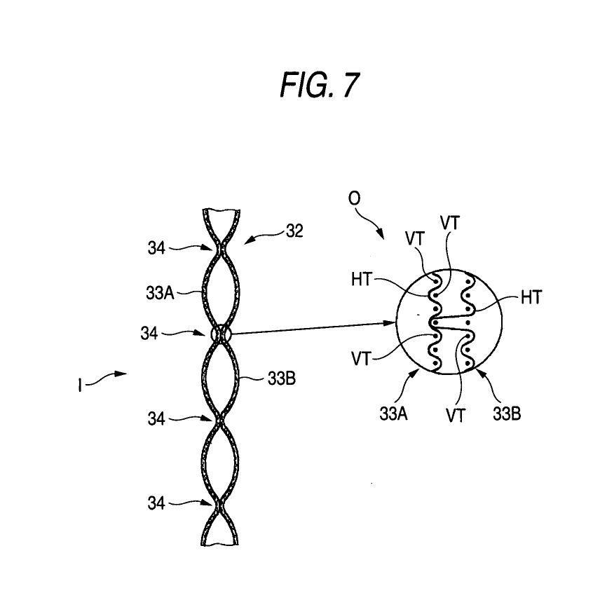

As illustrated in FIGS. 4, 5, and 7, the outer edge portion 32 is constituted by two cloth pieces 33A and 33B formed by being separated the adjacent marginal portion 31 into an interior-side part I and an exterior-side part O and being then woven. In the case of the present embodiment, each of the cloth pieces 33A and 33B is set to be substantially equal to each of the interior-side wall portion 21a and the exterior-side wall portion of the gas inflow portion 21 in the number of the warp threads VT and the weft threads HT per square inch. As illustrated in FIGS. 4 and 7, the outer edge portion 32 of the embodiment is formed by scattering a large number of stitched portions 34 thereover, which are formed by interweaving the warp thread VT or the weft thread HT used to weave one 33A of the two cloth pieces into the warp thread VT or the weft thread HT used to weave the other cloth piece 33B. In the embodiment, the stitched portions 34 are formed substantially at intervals of 5 mm. The outer edge portion 32 is configured so that the width of a part arranged at a side opposite to the direction, in which the tensile force acts on the mounting portion 30, that is, each of the width t3 of the upper part 32a and the width t4 of the front side part 32b and the rear side part 32c is set to be 5 mm or more (preferably, 5 mm to 20 mm) (see FIG. 4). Even when the airbag 20 expands and inflates, so that a large tensile force acts on the mounting portion 30 downwardly, or obliquely frontwardly or rearwardly downwardly, and that frays due to thread cast-off are caused over the entire adjacent marginal portion 31, the outer edge portion 32 cannot withstand the tensile force. Thus, there is a fear that frays due to thread cast-off of the warp threads VT and the weft threads HT may be caused at the circumferential edge of the mounting hole 30a, and that the adjacent marginal portion 31 may be damaged. Even in a case where each of the widths t3 and t4 is 20 mm or more, no more advantages can be obtained. Thus, waste of a material is caused. Preferably, each of the widths t3 and t4 is set to be less than 20 mm. In the case of the present embodiment, each of the width t3 of the upper part 32a and the width t4 from each of the front part 32 and the rear part 32c is set at 10 mm.

In the case of the present embodiment, as illustrated in FIG. 2, the mounting bracket 9 having an inner panel 9a and an outer panel 9b respectively placed at the interior side I and the exterior side O of each of the mounting portions 30 is fixed to each mounting portion 30. Each of the mounting portions 30, together with an associated one of the mounting brackets 9, is fixed to the inner panel 2 at the side of the body 1, using the mounting bolt 10 serving as the mounting means.

The airbag 20 according to the embodiment can be manufactured by cutting a hollow weave into a predetermined shape and sewing the connecting cloth 39. In the case of the embodiment, the airbag 20 is hollow-woven by using 6-6 nylon original yarns having a fineness of 350 dtex and by setting the number of driving warp threads VT per inch at 65.5 and also setting the number of driving weft threads HT per inch at 58.8. A hollow weave hollow-woven by using 6-6 nylon original yarns having a fineness of 350 dtex and by setting the number of driving warp threads VT per inch at 67.5 and also setting the number of driving weft threads HT per inch at 60.5 can be used as the material of the airbag. Alternatively, a hollow weave hollow-woven by using 6-6 nylon original yarns having a fineness of 470 dtex and by setting the number of driving warp threads VT per inch at 56.0 and also setting the number of driving weft threads HT per inch at 50.5 can be used as the material of the airbag.

A process of mounting the airbag 20, which is manufactured as described above, in the vehicle V is described below. First, the airbag 20 is folded by accordion-folding so that the side of a bottom edge 20b is made to approach the top edge 20a. After the airbag is folded, a predetermined part of the airbag 20 is enwrapped by breakable tape (not shown) for preventing breaking of the folded state of the airbag.

Next, the inflator 15, to which the mounting bracket 16 has been attached, is connected to the connecting port portion 22 of the airbag 20 by utilizing the clamp 18. Thus, an airbag assembly is formed by fixing the mounting bracket 9 to each of the mounting portions 30 of the airbag 20.

Subsequently, a mounting bracket 16 is placed at a predetermined position of the inner panel 2 at the side of the body 1. The inflator 15 is fixed to the inner panel 2 with bolts 17. Also, each of the mounting portions 30, together with the associated mounting bracket 9, is attached to the inner panel 2 by utilizing the mounting bolt 10. Thus, the airbag assembly can be attached to the body 1. Then, a lead wire (not shown) extending from the control unit for operating the predetermined inflator is connected to the inflator 15. The front pillar garnish 3 and the roof head lining 4 are attached to the body 1. Additionally, the rear pillar garnish 6 and the center pillar garnish 6 and the center pillar garnish 5 are attached to the body 1. Thus, the head protecting airbag apparatus M can be mounted in the vehicle V.

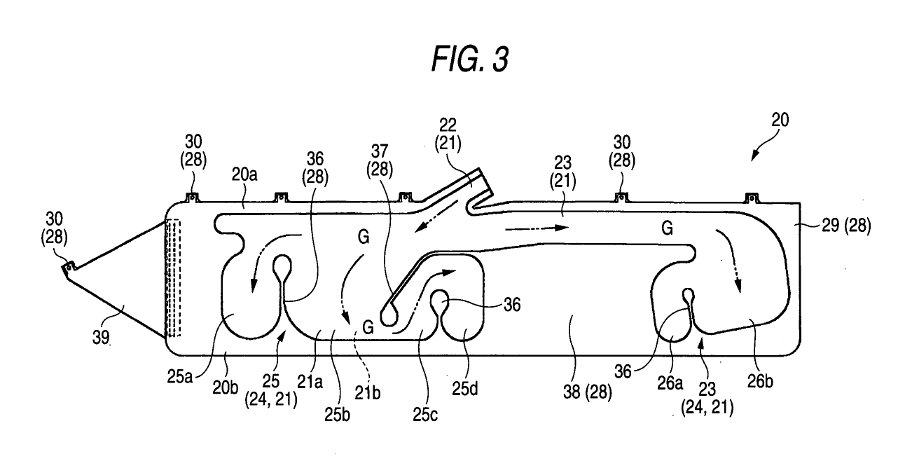

In a case where the inflator 15 is activated after the head protecting airbag apparatus M is mounted in the vehicle V, inflation gas G from the inflator 15 is caused to flow into the gas supply path portion 23 from the connecting port portion 22 of the airbag 20, as indicated by double-dashed-chain lines shown in FIG. 3. The inflation gas G then flows in the gas supply path portion 23 toward both the frontward and rearward sides. Subsequently, the front protecting inflation portion 25 and the rear protecting inflation portion 26 start inflating, while eliminating the folding. Then, the airbag 20 is downwardly protruded by breaking the tape (not shown), with which the airbag 20 is wrapped, and by pushing and opening the airbag cover 7 at the side of the bottom edge 3a of the front pillar garnish 3 and the bottom edge 4a of the roof head lining 4. Thus, as indicated by double-dashed-chain lines in FIG. 2, the airbag 2 largely expands and inflates so as to cover the interior-side 1 of each of the side windows W1 and W2, the center pillar portion CP, and the rear pillar portion RP.

The airbag 20 is constituted by a hollow weave hollow-woven as a single ply so that the adjacent marginal portion 31 constituting the marginal part of the mounting hole 30a of each of the mounting portions 30 so as to connect the interior-side wall portion 21a and the exterior side wall portion 21b to each other. However, additionally, the outer edge portion 32 formed by separating the adjacent marginal portion 31 into an interior side part and an exterior part which are then woven, is provided at the outer circumferential side of the adjacent marginal portion 31. Thus, in the airbag 20 of the embodiment, when the airbag 20 expands and inflates, a large downward tensile force acts on the mounting portions 30. Even when the warp threads VT and the weft threads HT constituting the adjacent marginal portion 31 may fray, in a border part between the adjacent marginal portion 31 and the outer edge portion 32, in which the weave changes, the warp and weft threads become difficult to come off, due to resistance caused by the interweaving between the warp threads VT and weft threads HT of each of the two separate cloth pieces. Consequently, occurrence of a fraying phenomenon can be prevented. Also, such a fraying phenomenon can be suppressed from running to the outer edge portion 32 provided at the outer circumferential side of the adjacent marginal portion 31. Consequently, according to the head protecting airbag 20 of the embodiment, even when a large tensile force acts directly and drastically on the circumferential edge of the mounting hole 30a of the mounting portion 30, the circumferential edge of the mounting hole 30a can be prevented from fraying. Also, the mounting portion 30 can be prevented from being damaged. Even when frays are caused over the entire adjacent marginal portion 31 in the head protecting airbag 20 according to the invention, frays can be prevented from running to the outer edge portion 32. Thus, it is unnecessary to increase the size of the mounting portion beyond necessity. As compared with the case of employing the mounting portion 30 constituted by a hollow weave the entire of which is hollow weaved as a single-ply, the mounting portion 30 can be compacted. Additionally, according to the head protecting airbag 20 of the invention, the adjacent marginal portion 31 and the outer edge portion 32 of the mounting portion 30 can be integrally manufactured when the airbag is hollow-woven. Consequently, the number of manufacturing-man-hours and the manufacturing cost can also be suppressed from increasing.

Accordingly, the head protecting airbag 20 according to the invention is easy to manufacture and is enabled so that each mounting portion 30 is stably attached to a body (i.e., a vehicle body) 1 without being damaged even in a case where a large tensile force acts drastically and directly on a marginal part of a mounting hole 30a of the mounting portion 30 when the airbag 20 expands and inflates.

The airbag 20 of the embodiment can be configured so that the two cloth pieces 33A and 33B constituting the outer edge portion 32 are formed by scattering stitched portions 34 thereover, which are formed by interweaving, when at least one 33A of the two pieces is woven, the warp thread VT or the weft thread HT used to weave at least one of the two cloth pieces into the other cloth piece 33B. Thus, the two cloth pieces 33a and 33B of the outer edge portions 32 are partially connected by the stitched portion 34. This head protecting airbag is preferable in that the two cloth pieces 33A and 33B can be prevented from slipping off each other. Apparently, in no consideration of this respect, no stitched portions may be provided in the outer edge portion.

Also, in the airbag 20 of the embodiment, the weave constituting the adjacent marginal portion 31 is constituted by a 4×4 weave. Thus, the tensile strength of the adjacent marginal portion 31 can be set to be high. Further, the adjacent marginal portion 31 is configured so that the distance from the mounting hole 30a to the outer edge portion 32 placed at a side opposite to a direction in which a tensile force acts on the mounting portion 30 when the airbag 20 expands and inflates, that is, each of a distance t1 from the top edge of the mounting hole 30a to the top end of the adjacent marginal portion, and a distance t2 from each of the front and rear edges of the mounting hole 30a to an associated one of the front and rear ends of the adjacent marginal portion 32 is set to be equal to or more than 10 mm (preferably, 10 mm to 20 mm). In a case where each of the distances t1 and t2 is less than 10 mm, when the airbag 20 expands and inflates, so that a large tensile force acts on the mounting portion 30 downwardly, or obliquely frontwardly or rearwardly downwardly, the adjacent marginal portion 31 can appropriately receive the tensile force. Apparently, in a case where the hollow weave constituting the adjacent marginal portion 31 is constituted by a 3×3 weave, the adjacent marginal portion 31 can assure the sufficient tensile strength.

Also, according to the airbag of the embodiment, in the outer edge portion 32 is configured so that the width of a part arranged at a side opposite to the direction, in which the tensile force acts on the mounting portion 30, that is, each of the width t3 of the upper part 32a and the width t4 of the front side part 32b and the rear side part 32c is set to be 5 mm or more (preferably, 5 mm to 20 mm). Thus, even when the airbag 20 expands and inflates, so that a large tensile force acts on the mounting portion 30 downwardly, or obliquely frontwardly or rearwardly downwardly, and that frays due to thread cast-off are caused over the entire adjacent marginal portion 31, the outer edge portion 32 can suppress the adjacent marginal portion 31 from being broken due to the frays.

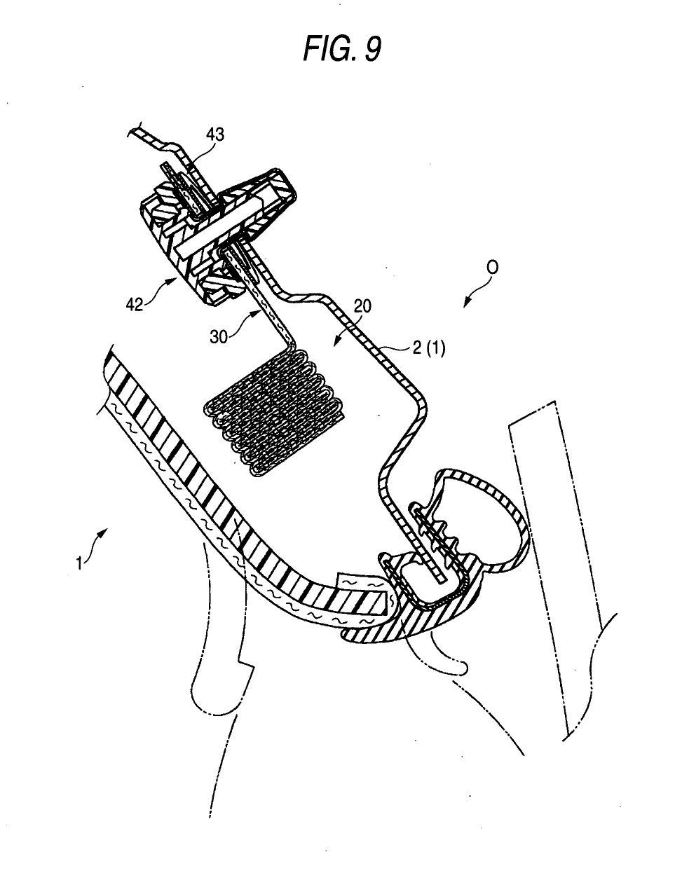

In the foregoing description of the embodiment, it has been described that all the mounting portions 30 of the airbag 20 are attached to the body 1, using the mounting brackets 9 and the mounting bolts 10. However, as illustrated in FIG. 9, each of the mounting portions 30 can be attached to the inner panel 2, utilizing a clip 42 and a pressing plate 43 provided on the exterior side O thereof.

What is claimed is:

1. Ahead protecting airbag configured so that said airbag is folded and accommodated in an interior-side upper edge part of a window, that the airbag expands and inflates, when inflation gas flows thereinto, to cover an interior side of said window, that said airbag has a plurality of mounting portions for mounting said airbag in a part of a vehicle body at an upper edge side of said window, which are provided in an upper edge part thereof in a state in which expansion and inflation thereof are completed, that a mounting hole, through which mounting means to be connected to said part of said vehicle body is passed, is provided in each of said mounting portions, and that said airbag is formed of a hollow weave including warp and weft threads, said head protecting airbag, comprising:
a gas inflow portion configured to be inflated by flowing inflation gas thereinto to separate an interior-side wall portion from an exterior-side wall portion; and
a non-inflow portion in which no inflation gas is flowed,
wherein said non-inflow portion has said mounting portions and marginal border portions surrounding said gas inflow portion;
each of said mounting portions includes:
an adjacent marginal portion which is provided to extend outwardly from said marginal border portion and which is formed of a hollow weave as a single-ply so as to connect said interior-side wall portion and said exterior-side wall portion to each other and as to constitute a marginal border of an associated one of said mounting holes; and
an outer edge portion including two cloth pieces which are arranged on an outer circumferential side of said adjacent marginal portion and are formed of said adjacent marginal portion by being separated from each other into an interior side part and an exterior side part.

2. The head protecting airbag according to claim 1, wherein said two cloth pieces constituting said outer edge portion are formed by scattering stitched portions thereover, which are formed by interweaving, when at least one of said two pieces is woven, the warp thread or the weft thread used to weave at least one of said two cloth pieces into the other cloth piece.

3. The head protecting airbag according to claim 1, wherein said hollow weave constituting said adjacent marginal portion includes a 4×4 weave.

4. The head protecting airbag according to claim 1, wherein said hollow weave constituting said adjacent marginal portion includes a 3×3 weave.

5. The head protecting airbag according to claim 1, wherein each of said adjacent marginal portions is set so that a distance from an associated one of said mounting holes to an associated one of said outer edge portions, which is disposed at a side opposite to a direction in which a tensile force acting on said mounting portion acts, is 10 mm or more.

6. The head protecting airbag according to claim 1, wherein each of said outer edge portions is such that a width of a part disposed at a side opposite to a direction, in which a tensile force acting on said mounting portion acts, is 5 mm or more.
